(19) United States
(12) Patent Application Publication
(10) Pub. No.: US 2014/0308408 A1
(43) Pub. Date: Oct. 16, 2014

(54) REGRIGERATED CHEMICALLY LEAVENED DOUGH IN PRESSURIZED CONTAINER

(71) Applicant: GENERAL MILLS, INC., Minneaplis, MN (US)

(72) Inventors: David J. Domingues, Plymouth, MN (US); Scott Kackman, New Hope, MN (US); David A. Kirk, Coon Rapids, MN (US); Jason Nagy, Maple Grove, MN (US); Tal Tostenson, Rogers, MN (US); Matthew W. Lorence, Plymouth, MN (US)

(73) Assignee: General Mills, Inc., Minneaplis, MN (US)

(21) Appl. No.: 13/863,881

(22) Filed: Apr. 16, 2013

(51) Int. Cl. A21D 10/02; B65B 31/04; B65B 53/00; B65D 81/20

(52) U.S. Cl. CPC A21D 10/025; B65D 81/2061; B65B 31/04; B65B 53/00
USPC 426/118; 426/128; 426/391; 53/440

(57) ABSTRACT

Described are refrigerator-stable, chemically-leavened dough compositions, packaged dough products, and methods for preparing the same, wherein the dough compositions can be packaged and stored in a pressurized package.

### FIELD OF THE INVENTION

The invention relates to refrigerator-stable, chemically-leavened dough compositions, packaged dough products that include the dough in a pressurized container, related packages, and methods for preparing the same.

### BACKGROUND

Refrigerated, packaged dough products are a popular consumer item due to their storage stability, convenience of use, and desirable baked properties (flavor, texture, coloration, aroma), which can be on par with freshly baked bread products. Many refrigerated dough products are sold commercially, packaged to be refrigerator-stable in a consumer-type package. The package is often pressurized to have an internal pressure that is greater than atmospheric, with many commercial products having internal pressures above two atmospheres absolute. Pressurized packaging configurations are used, for example, for dough products such as chemically-leavened biscuits, sweet rolls, donuts, pizza doughs, rolls, other various forms of breads, as well as many other types of dough and bread products.

Pressurized packages, for example pressurized cans or canisters, provide consumer dough products with convenience and storage stability. Such packages can be easily prepared, handled, stored, and transported, and can be sized to contain a useful number of portions of a raw dough product. Normally, pressurized packages are refrigerator stable and capable of being stored at a refrigerated temperature for extended periods of time, e.g., several weeks, while keeping the contents fresh.

An example of one type of pressurized package is a self-sealing can or canister, commonly used to package such refrigerated dough products as chemically leavened biscuits. The dough composition is placed within an interior of the can or canister. Leavening agents in the dough produce carbon dioxide, causing the dough to expand within the container. The expanding dough fills the interior of the package, seals the package from the inside, and then pressurizes the package. To contain its pressurized contents, the container and the materials of the container must be of sufficient strength and construction to withstand the internal pressure without breaking or deforming. A typical construction is a wound cardboard can with two metal end closures. While these pressurized cans are a useful packaging configuration, they are expensive at least in part because of the metal end closures.

A commercial desire continually exists for useful dough packages that can be refrigerated, contain a dough under pressure, and that exhibit storage stability and baking performance similar to pressurized cans. Generally, the commercial dough industry has ongoing need for improvements in product and packaging configurations, including cost reductions. In this effort, flexible packages have been used, along with various different dough formulations effective to provide pressurized or non-pressurized packages. To date, efforts continue in the use of flexible packages.

### SUMMARY

The invention relates to dough compositions, dough compositions packaged in pressurized packages, and related methods. The commercial standard for pressurized dough containers is a pressurized wound cardboard can with metal end closures or “caps.” The metal caps define a vent between the can end and the metal cap. The vent allows for gas to discharge from the interior of the container as the dough expands within the interior, after which the expanded dough seals the vent and subsequently continues to expand and build pressure within the container. One disadvantage of these can-type packages is the cost of the metal end closures (caps) at the ends of the cans.

Packages as described herein function differently, in that the described packages do not require a dough to expand within a container to seal the container from the interior. In addition, the described packages include a flexible container, optionally with a secondary (e.g., outer) container. The flexible container alone, or the flexible and optional secondary (outer) container together are designed to prevent excessive expansion (volume increase) of the dough within the container, during refrigerated storage; the packages is pressurized, but the volume of the package is well controlled.

The controlled volume and pressurized interior of the package produce a contained dough composition that, during refrigerated storage, exhibits what is referred to by the present description as an “expansion potential” within a desired range, the expansion potential being a function of the “contained” raw specific volume of the dough in the package and the internal pressure of the package. The expansion potential (having units of cubic centimeters per gram, per pound per square inch (absolute)) is the ratio of the contained raw specific volume of the dough composition, to the internal pressure of the dough package. In preferred package embodiments the expansion potential can be in a range from about 0.012 to about 0.026. To control or prevent an undesired increase in the volume of a packaged dough during refrigerated storage, and to maintain a desired expansion potential of the dough throughout a refrigerated storage period, the package is designed to exhibit dimensional stability under pressure, and is prepared from materials that afford that dimensional stability. A controlled volume during a refrigerated storage period can mean a volume that increases during the refrigerated storage period by not more that 10 percent, e.g., not more than 7 percent, relative to the volume of the raw dough at the time the dough is placed in the package and the package is assembled and closed (e.g., sealed).

Accordingly, a package that includes a flexible packaging material is constructed to minimize and to prevent any more than a small amount expansion of a contained dough composition during a refrigerated storage period; the amount of expansion should be an amount that holds the packaged dough product within a desired range of expansion potential; the amount of expansion should preferably not be so great as to cause the packaged dough product to achieve an expansion potential that is outside of the desired range (e.g., from 0.012 to about 0.026 cubic centimeters per gram, per pound per square inch (absolute)). The package exhibits dimensional stability, under pressure, over an extended refrigerated storage period of a few weeks, several weeks, and up to or exceeding twelve weeks. Dimensional stability that prevent a volume increase of any more than 10 percent, can be achieved by using a flexible packaging material that is resistant to stretching or deformation over a time range of the extended refrigerated storage period.

In one aspect, the invention relates to a refrigerated packaged dough product that includes a chemically leavened dough composition contained inside a pressurized package. The packaged dough product includes a flexible package defining an interior volume, with the dough composition located in the interior volume. The dough composition has a contained raw specific volume of from about 0.9 to about 1.1 cubic centimeters per gram measured within the flexible package. The flexible package contains less than 2 percent headspace and has an internal pressure of from 7 to 20 pounds per square inch (gauge). And the ratio of the contained raw specific volume to the pressure (absolute) is in a range from about 0.012 to about 0.026 cubic centimeters per gram per pound per square inch (absolute).

In another aspect, the invention relates to a method of preparing a packaged dough product that includes a chemically leavened dough composition inside a pressurized package. The method includes: providing a chemically leavened raw dough composition; providing a flexible package defining an interior volume; placing the raw dough composition in the interior volume with the interior volume containing less than 2 percent headspace, while the dough composition has a raw specific volume of from about 0.9 to 1.1 cubic centimeters per gram, and storing the packaged raw dough at refrigerated storage conditions for a refrigerated storage period of at least 2 weeks. During the refrigerated storage period: the package has an internal pressure of from 7 to 20 pounds per square inch (gauge); and the ratio of the contained raw specific volume to the pressure (absolute) is in a range from about 0.012 to about 0.026 cubic centimeters per gram per pound per square inch (absolute).

In yet another aspect, the invention relates to a packaged dough product that includes a chemically leavened dough composition inside a pressurized package. The product has: a dimensionally stable outer package having two ends and an outer package volume between the ends; and a flexible inner package at least partially contained by the outer package volume, the flexible package defining an interior volume. The packaged dough product can be stored for a refrigerated storage period of at least 4 weeks, and from the time the dough composition is placed in the flexible package and through the refrigerated storage period, the contained raw specific volume does not increase by more than 10 percent.

### BRIEF DESCRIPTION OF THE FIGURES

FIGS. 1A, 1B, and 1C illustrate embodiments of a packaged dough product.

FIG. 2 illustrates an embodiment of a packaged dough product.

FIGS. 3A, 3B, 3C, 3D, and 3E illustrate embodiments of packaged dough products.

FIGS. 4A, 4B, and 4C illustrate embodiments of a packaged dough product.

FIGS. 5A and 5B show embodiments of packaged dough products of the invention, and a control.

FIG. 6 shows an embodiment of an outer sleeve package component.

FIGS. 7A, 7B, and 8 show embodiments of packaged dough products.

FIG. 9 shows data of change in package volume during refrigerated storage for various packaged dough products.

FIG. 10 shows data of pouch specific volume during refrigerated storage for various packaged dough products.

FIG. 11 shows data of baked specific volume following refrigerated storage for various packaged dough products.

FIG. 12 shows data of expansion potential during refrigerated storage for various packaged dough products.

### DETAILED DESCRIPTION

Dough compositions useful in the packaged dough products include chemically-leavened (or “chemically-leavenable”) dough compositions, meaning dough compositions that leaven to a substantial extent by the action of chemical leavening agents that react to produce a leavening gas such as carbon dioxide. Typically the chemical leavening agents include a basic chemical leavening agent and an acidic chemical leavening agent, the two of which react to produce carbon dioxide which, when retained by the dough matrix, causes the dough to expand, or, if the dough volume is contained in a fixed volume container, causes pressure to build within the container.

Chemically-leavened doughs can be contrasted to dough formulations that are substantially leavened due to the action of yeast as a leavening agent, i.e., by metabolic action of yeast on a substrate to produce gaseous carbon dioxide. While doughs of the described packaged dough products can include yeast, e.g., as a flavoring agent, certain dough compositions of the invention do not include and can specifically exclude yeast as a leavening agent.

According to the invention, a chemically leavened dough composition can be packaged for refrigerated storage in a pressurized flexible package. The pressurized flexible package may be the entire package structure, or may be an inner component of a multi-piece package that includes an outer package structure in combination with the pressurized flexible package. The package includes at least one flexible (inner, or only) packaging material, and may include a secondary outer packaging material that may be either flexible, semi-flexible, semi-rigid, or rigid.

The flexible package defines an interior volume within which the dough composition is contained. The package, with the dough composition placed inside the interior volume, also can preferably contain only a low amount of headspace, such as less than 5, 2, or 1 percent headspace. In some embodiments the amount of headspace is low because the size of the dough composition is nearly the same as the size of the interior volume of the flexible package; in other embodiments the volume of the flexible package can be greater than the volume of the dough (e.g., at least 5 or 10 percent greater), in which case the headspace can be reduced by collapsing (to produce folds or wrinkles) the flexible package to match the volume of the contained dough composition.

In assembly, the flexible package is prepared and a dough composition is placed in the interior volume either as a separate step or during the same processing steps. The amount of headspace in the flexible package is made to be low, either by matching the dough volume to the interior volume of the package, or by removing headspace from an oversized flexible package by collapsing the volume of the flexible package to nearly match the dough volume. Then the flexible package is closed or sealed.

At the time the dough composition is placed within the package and the package is closed with a low headspace, the raw specific volume of the dough is an “original” raw specific volume in a range from about 0.9 to about 1.1 cubic centimeters per gram. The pressure inside of the package is approximately atmospheric. As a general matter, upon placement of such a chemically leavened dough composition in a package and closure of the package, chemical leavening agents in the dough will react to produce carbon dioxide. Still generally, the amount of carbon dioxide will build within the dough composition to produce one of the following possible outcomes: the dough composition can expand within the flexible package and the volume of the dough composition (and in some instances the flexible package) can increase; the pressure of the dough composition within the package can increase; or the dough volume can increase and the internal pressure can increase.

According to the invention, upon placement of such a chemically leavened dough composition in a package and closure of the package, chemical leavening agents in the dough will react to produce carbon dioxide. Subsequently, shortly after closure and during a subsequent refrigerated storage period, internal pressure within the flexible package can increase, but volume of the contained dough composition can be controlled to not increase by more than about 10 percent, preferably less than 7 percent or less than 5, 2, or 1 percent, compared to the volume of the dough when the dough is placed in the package and the package is assembled and closed. Desirably, the raw specific volume (measured within the package) of the packaged dough composition during a refrigerated storage period can be kept to below about 1.1 cubic centimeters per gram.

Because the dough volume and dough volume increase within the package are controlled, the increased carbon dioxide content of the dough will cause an increase of pressure within the package after placement of the dough in the package and during refrigerated storage. This too is maintained within a desired range according to the described packaged dough products and methods. Desirably, the internal pressure within the flexible package can build to a pressure in a range from about 7 to about 20 pounds per square inch (gauge), such as from about 10 to about 15 psig, and the dough contained in the package can have a raw specific volume in a range from 0.9 to 1.1 cubic centimeters per gram (this raw specific volume of the dough, measured while the dough is in the package, is referred to as the “contained” raw specific volume).

According to the present description, a packaged dough product is prepared to achieve desired refrigerated storage stability and baked performance properties of the packaged dough (including baked specific volume). According to certain embodiments, a dough product and dough package can be provided such that when the dough is placed in the package and stored at a refrigerated condition, at elevated pressurize and relatively constant volume, the dough can be removed from the package and will expand do a desired “released” raw specific volume, such as in a range from about 1.3 to about 1.4. The unpackaged dough can be cooked (e.g., baked) to a baked or otherwise cooked dough product having useful or advantageous baked properties such as baked specific volume, e.g., a baked specific volume of at least 2.7 cubic centimeters per gram.

The packaged refrigerated dough product can be stored at a refrigerated condition in a manner that maintains a desired “expansion potential.” “Expansion potential” is a value, identified by the Applicant, that can be generated by determining the raw specific volume of a packaged dough composition measured with the dough in the package (i.e., the “contained” raw specific volume), and dividing that contained raw specific volume by the internal pressure of the package (in units of pounds per square inch (absolute)) (its units are cc/gm/psia). This “expansion potential” value has been identified to function as a predictive value of bake performance, especially baked specific volume. Useful or preferred bake performance can occur with refrigerated, chemically leavened packaged dough compositions that exhibit an expansion potential in a range from about 0.012 to about 0.026 cc/gram/psia (e.g., from 0.13 to 0.020 cc/gram/psia). To achieve the specified expansion ratio in a packaged dough product, certain ranges of internal package pressure and contained raw specific volume may be particularly useful. Also, the package that includes the dough composition desirably includes limited headspace, such as less than 5, 2, or 1 percent headspace. To maintain a desired expansion potential during a refrigerated storage period, preferred packages can be dimensionally stable under pressure during the refrigerated storage period, to prevent a change in the internal volume of the container (and a resultant change in the contained raw specific volume of the dough composition) that would cause the expansion potential of a packaged dough product to move outside of a desired range.

Without being bound by theory, the “expansion potential” value of a pressurized, refrigerated chemically-leavened dough product is now shown to be a useful dough parameter that can advantageously be used to prepare stable, chemically leavened refrigerated doughs with desirable bake properties. Identification of the expansion potential value itself required a realization, heretofore unknown, of the important inter-relationship between the internal package pressure of a pressurized dough product, the fragility of the bubble-in-dough-matrix structure of the contained dough, and the effect that de-pressurization (especially rapid de-pressurization) can have on that fragile dough matrix when the pressurized package is opened. The dough composition is a fragile structure made of gas cells formed within a matrix of the dough material. When contained in a pressurized dough package, each gas cell is pressurized (relative to ambient). When the pressurized package is abruptly opened, the dough—and more importantly the gas contained in the dough cells—quickly expands due to the pressure release. The amount of the expansion (the increase in volume of the dough upon release of the dough from the pressurized package), and the rate of the expansion, which are affected by the internal package volume, are now understood to affect (i.e., diminish) bake performance of the dough.

As an example, an internal pressure that is too high can cause reduced bake performance. A high internal pressure can cause excessive expansion of the dough upon removal from the pressurized package, which can damage the gas cells. Gas cell damage can occur due to excessive pressure within the dough container, and expansion of the gas within the dough cell structure that occurs too rapidly. When a package with excessive internal pressure is abruptly opened, pressure is removed quickly and the pressure differential between the ambient atmosphere and the pressure in a gas cell can cause gas the gas in the cell to quickly expand in a manner that will cause the cell to rupture. Multiple ruptured cells in a dough composition can lead to a loss in overall gas holding capacity of the dough composition due to fewer (and larger) gas cells.

It is also understood that an internal package pressure that is insufficiently high, i.e., is too low, can reduce baked specific volume of a refrigerated, pressurized packaged dough, but for different reasons. As opposed to excessive expansion upon opening a pressurized package having too high of an internal pressure, causing damage to cells of the dough matrix, a dough that is under too little pressure during storage and when the package is opened can also exhibit undesirably low baked specific volume. A dough package may contain relatively lower internal pressure if the contained dough has expanded too much within the package prior to opening; a larger volume within the package, and greater expansion during storage, correlate to a lower internal pressure as compared to a dough that has experienced less expansion within a smaller volume. With a more expanded dough matrix in the package, and a lower internal pressure, the cell structure of the dough matrix when the dough is removed from the package can collapse (or may not expand by a desired amount) because the pressure within the cells of the dough matrix is insufficient. The collapsed dough structure can lead to a low raw specific volume of the dough outside of the package (the “released” raw specific volume), which can result in a low baked specific volume.

According to the invention, and the described novel understanding of the relationship between the internal pressure of a packaged dough product, the raw specific volume of the dough within the package, and the effects that these parameters can have on bake properties of the dough, it is now understood that controlled expansion of a dough product upon removing the dough from a pressurized package can lead to desired and increased baked volume of the dough by avoiding loss or rupture of internal gas cell structure (due to excessive internal pressure), and a collapsed or insufficiently expanded dough structure (due to insufficient internal pressure). The controlled expansion can be a rate and extent (volumetrically) of expansion that result from a desired combination of: internal pressure of a packaged dough product; and, density of the dough (alternately, raw specific volume) within the package prior to opening. These can be controlled (during a refrigerated storage period) by designing a packaged dough product to exhibit an “expansion potential” value as described herein, and by use of a package that exhibits dimensional stability under pressure to maintain that expansion potential during a period of refrigerated storage.

During refrigerated storage of a packaged dough product, exemplary internal pressures can be in a range from about 7 to about 20 pounds per square inch (gauge), preferably from about 10 to 15 pounds per square inch (gauge), e.g., from about 14 to about 15 psig. The contained raw specific volume may be in a range from about 0.9 to about 1.1 cubic centimeters per gram, e.g., from about 0.95 to about 1.1 cc/gram, or from about 1 to about 1.05 cc/gram. Preferred packaged dough compositions can exhibit a combination of internal pressure and contained raw specific volume within these ranges (during refrigerated storage) to result in an expansion potential of at least 0.012 cc/gm/psia, such as an expansion potential in a range from about 0.012 to about 0.26 cc/gm/psia, or an expansion potential in a range from about 0.013 to about 0.20. Also preferably, the dough composition upon removal of the internal pressure (i.e., upon de-pressurization) can expand to a released raw specific volume that results in good bake performance, such as a released raw specific volume in a range from about 1.3 to about 1.4 cubic centimeter per gram. A desired baked specific volume may be at least 2.7 cc/gram, e.g., at least 3.0 cc/gram.

Also preferably, upon de-pressurization, the entire dough contents of the package can be de-pressurized within a very short amount of time (less than a second) to allow the contained dough to expand uniformly and substantially all at once and to a uniform raw specific volume. For example, the dimensional constraint of the package on the contained dough can be released from all of the dough quickly and uniformly, so that the pressure release does not cause some of the total amount of dough to expand immediately or partially (such as by expanding partially out of a partially opened package) while a remaining portion is still dimensionally constrained by the package. Preferably, de-pressurization and expansion of the entire dough composition contained in a package can occur within a matter of seconds, e.g., less than 1 cc/gram/second, such as less than about 0.7 cc/gram/second.

According to preferred embodiments of the packaged dough product, the packaged product can be stored at a refrigerated condition (e.g., from 38 to 45 degrees Fahrenheit) for an extended period, such as up to 2, 4, 6, 8, 10, 12, or more weeks at a refrigerated temperature, and retain some of the described properties of desired internal pressure, contained raw specific volume, expansion potential, etc. In particular, described packaged dough products can maintain a desired expansion potential by use of a package that exhibits dimensional stability under pressure, to prevent undue volume increase of the dough within the package during refrigerated storage, which would result in an increased contained raw specific volume and a decreased internal pressure, possibly causing the expansion potential value to move out of a desired range.

In the context of the present description, “dimensional stability” refers to the ability of a dough package to exhibit a stable volume during refrigerated storage, while the package is pressurized as described, and while the package contains a volume of dough suited for consumer sale (e.g., to experience a volume increase during a refrigerated storage period that is not greater than about 10 percent). A packaging material that can be useful to produce a package having dimensional stability can also be referred to as exhibiting “dimensional stability.” The dough package can be of any size, and is typically of a size suitable for a raw dough product sold to commercial or consumer customer. Many cans, canisters, pouches, chubs, and similar packages include an elongate cylindrical or tube-like structure. Such a packaged dough product may contain an amount of dough to be used during a single meal or a single mealtime by a group of individuals such as a family. Exemplary packages for dough compositions such as sweet rolls, breads, rolls, buns, biscuits, pizza crusts, and others, may have exemplary dimensions that include an interior space volume in the range from 50 to 800 cubic centimeters, e.g., from 200 to 500 cubic centimeters. Stated differently, an interior volume of a package may be sized and shaped to contain a desired volume (e.g., based on number or portions) of dough product, for example, for some retail-sale products, to contain from 1 to 10 chemically leavened biscuits dough pucks; volumes outside of this range may also be useful for biscuit or other dough products.

A package may be of any three-dimensional shape, defined by sidewalls and at least one opening, such as a cylinder (e.g., tube), a cube with one or more open end, a rectangular container with one or more open end, or any other three-dimensional shape or form having sidewalls and an opening. For a cylinder, tube, can, or canister, or similar cylinder-like shape (e.g., with a circular, round, or non-circular cross section), such as for a retail-type product, an exemplary length-wise dimension may be in the range of from 2 to 10 inches (from 5 to 25 centimeters), e.g., from 4 to 8 inches (from 10 to about 20 centimeters), and a diameter (for a round cross section), width (for non-round cross section), or other cross-sectional dimension, also optionally the dimension of an opening of the hollow container, may be in the range from about 1 to about 5 inches (from about 2.5 to about 12.5 centimeters), e.g., from about 2 to about 4 inches (from 5 to about 10 centimeters). Examples of these structures may also exhibit an aspect ratio (length to cross-sectional dimension such as diameter) in a range from about 1:1 to about 20:1, e.g., from about 2:1 to about 10:1.

For a package having a volume in a range from 50 to 800 cubic centimeters, and having an aspect ratio in a range from about 20:1 to about 1:1, a dimensionally stable package can be one that has a volume that does not increase by more than about 10 percent, e.g., not more than about 7 percent, such as less than 5 percent, preferably less than 3, 2, or 1 percent during a refrigerated storage period of 2, 4, 6, 8, 10, or 12 weeks. According to certain embodiments of packaged dough products, the dough contained in such a dimensionally stable package, can also exhibit an expansion potential in a range from about 0.012 to about 0.026 cc/g/psia, e.g., from about 0.013 to about 0.020 cc/g/psia, during a refrigerated storage period of at least 2, 4, 6, 8, 10, or 12 weeks.

The pressurized package as described can be constructed of any of various packaging materials, including a relatively low cost flexible package that defines an interior volume that directly contains the dough composition. The pressurized package is different from a conventional pressurized can or canister, at least due to the use of the flexible package, but also preferably due to the elimination of expensive metal ends. As used in the present context, a pressurized can or canister is a conventional pressurized dough product package in the form of a cylindrical tube (“can”) constructed of wound cardboard or paperboard, with two end pieces, generally metal, used to seal the opposite ends of the tube. The present description, as opposed to those conventional “can” packages for pressurized refrigerated, chemically-leavened dough products, allows for the use of a lower cost flexible package that directly contains the dough composition. The package may include a single flexible package, or may include multiple package pieces at least one of which is the flexible package.

The pressurized package (in any one-piece or multiple piece configuration) can preferably include at least one packaging material that produces a package having dimensional stability, i.e., a packaging material that is sufficiently dimensionally stable to provide the interior volume defined by the flexible package with dimensional stability as described herein, to allow dough packaged in the interior volume to exhibit a desired expansion potential throughout an extended period of refrigerated storage. Such dimensional stability is present in a pressurized package that does not increase by more than 10 percent in volume during a refrigerated storage period, and can be included in a pressurized package by use of a packaging material that exhibits low stretch or elongation over time at refrigerated storage conditions, under pressure, as described herein.

Examples of flexible package materials that exhibit dimensional stability sufficient to allow the material to maintain a desired expansion potential, during extended refrigerated storage periods, include certain types of polyethylene terephthalate (PET, or PETE), APET (amorphous polyethylene terephthalate, or polyester) (e.g., 12-mil (nominal thickness) APET, e.g., 12-13.4 mil APET base material with EVOH nylon polyethylene sealant or polypropylene-based sealant); PETE (blow molded PETE carbonate beverage bottle at 11 mil thickness); and 4.5 mil Oriented PET (e.g., 3.5 to 4.7 mil Oriented PET polymer with PE sealant base (with various levels of Nylon); (APET-cross direction; APET-machine direction; OPET machine direction; OPET cross direction. In contrast, packaging materials that do not exhibit dimensional stability sufficient to allow the material to maintain a desired expansion potential during extended refrigerated storage periods include various polypropylene and nylon materials, including certain polypropylenes; PET/cast polypropylene cross direction; Nylon-FT, and PET/cast polypropylene machine direction.

Preferred packages can also be configured to allow a user to uniformly release the pressure under which the dough exists when contained within the pressurized container. Embodiments of packages can include a pressure release device that is able to uniformly release the pressure in the interior volume of the package very quickly, such as in a period of less than a second, by uniformly removing the volumetric constraints placed on the dough by the package and allowing the dough to evenly expand. For the pressure release to be uniform, the internal pressure and volumetric constraint of the package may be released quickly along an entire length of the package, allowing the dough contents to expand in two dimensions away from a length axis of the package, while also optionally being released along the length axis to allow the dough contents to expand along the length axis. Certain embodiments of pressure release devices may optionally act to simultaneously release pressure within the package to allow the contained dough to expand (to a released raw specific volume), while also opening the package interior to allow the dough contents to be directly removed. Other embodiments may release pressure within the interior space of the package (e.g., of an “inner package”) and allow the dough to expand without also opening the package to allow direct removal of the dough contents; according to these embodiments, the package can be further manipulated or un-sealed to gain access to the dough contents for removal, after pressure is first removed from the dough contents. Certain preferred packages can be de-pressurized in a manner that removes volumetric constraints applied to a contained dough composition over a short time period, such over a matter of seconds, e.g., less than 1 seconds, such as less than about 1 second or less than about 0.7 seconds, this time referring to the period over which the major dimensional constrains (in at least two, preferably three dimensions) of the package are removed from the entire contents of dough within the package.

The pressurized package can include a flexible packaging material that defines an enclosed and pressurized interior volume within which the dough is contained during refrigerated storage in the package. The flexible pressurized package is generally referred to herein as the “flexible package,” and according to certain specific package embodiments (those that include an outer package), this “flexible package” may also be referred to as an “inner package.” The interior volume is “enclosed” in that the flexible package defines an interior volume on all sides. The package can define the interior volume in any air-tight manner, such as by one or more open ends being folded over to a sidewall to produce an air-tight seal at the fold, or ends and sidewalls being hermetically sealed by an adhesive, a mechanical closure, a sealant layer of a flexible packaging material, etc. to allow the interior volume to be pressurized. Optionally, the flexible package can be vented; for example a dough composition can be placed in a vented interior volume and can expand within the interior volume to close or seal the vent from the inside. Other embodiments do not require and can specifically exclude a vent of the interior volume.

The flexible package can be made of any generally flexible packaging material that is polymeric or paper-based; that is less rigid than cardboard packaging materials used to make sidewalls of conventional wound cardboard pressurized packages; and that that is generally elastic in that the flexible material is capable of being bent, folded, or wrinkled, without necessarily becoming permanently deformed and without compromising material properties. The flexible packaging material can exhibit mechanical properties that allow bending or folding of the packaging material to form a flexible package as described, such as one that defines a sealed cylindrical interior space. Examples of flexible packaging materials (which may or may not be dimensionally stable as that term is used herein) include flexible polymeric films such as polyesters (e.g., PET), nylons, polyolefins (e.g., polyethylene, polypropylene), vinyls, polyalcohols, etc. Generally, flexible polymeric film packaging materials are in the form of a flexible sheet or film having a thickness that is less than ⅛ inch, e.g., less than 1/16 inch, e.g., from 0.001 to 0.05 inch (1 to 50 mils), or from 0.01 to 0.015 inch (10 to 15 mils). The flexible packaging material of a flexible package may either be of a type that results in a desired dimensional stability of the flexible package, or may alternately be of a type that does not result in high dimensional stability of the flexible package.

A flexible packaging material (film) may include only one layer, or multiple layers, including two or more different layers that perform different functions including layers that act as a support layer, a barrier layer (for oxygen, carbon dioxide, moisture), a scavenger layer (polymer that includes scavenger), a sealant layer, and adhesive (e.g., thermoplastic) layer. A sealant can be a low temperature melt point polymer used to seal a package. A sealant layer is typically an interior layer of a packaging film and is sealed using time, elevated temperature, and pressure, to form the finished closed packaged product. An example of a useful material for a sealant layer is LDPE (low density polyethylene)/EVA (ethylene vinyl acetate) copolymer.

Certain preferred flexible packaging materials also exhibit useful bather properties to the transmission of gaseous oxygen or carbon dioxide through the packaging material. Useful according to the present description are barrier materials that have an oxygen transmission rate below about 5, 10, or 20, cubic centimeters per 100 square inches/day at 73° F.; e.g., less than 1 cubic centimeters per 100 square inches/day at 73° F., or less than 0.5 cubic centimeters per 100 square inches/day at 73° F.

The flexible package optionally and preferably functions as a bather to the passage of gases, especially as an oxygen barrier and a carbon dioxide barrier, substantially reducing or preventing passage of both oxygen and carbon dioxide from or into the package.

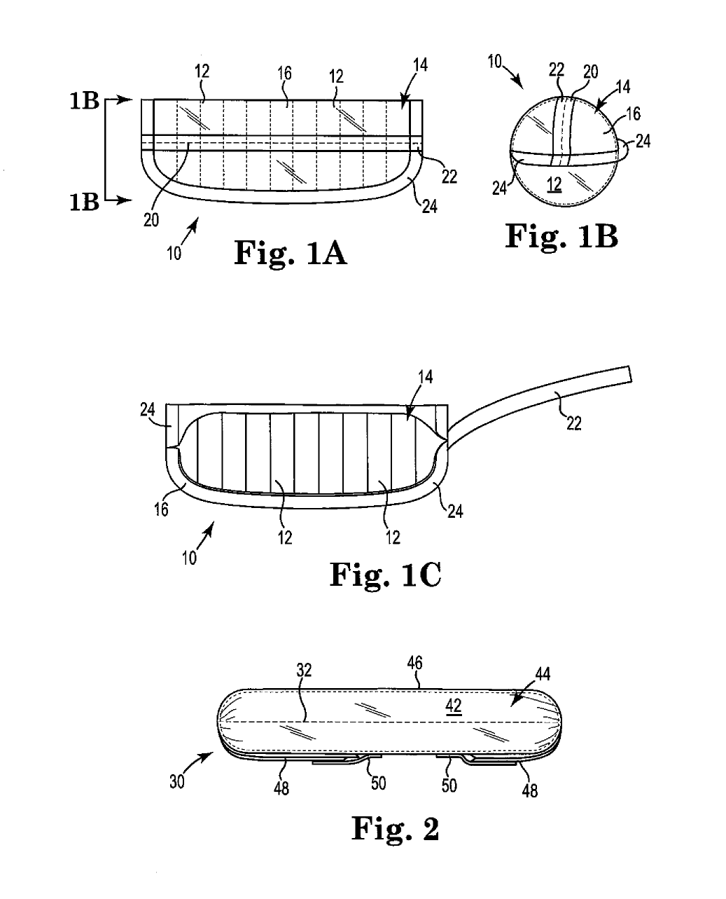

Some package embodiments include the flexible package and no additional package structure that supports the interior volume. See, e.g., FIGS. 1A, 1B, 1C, and 1D. In these embodiments, the flexible package can be made of a flexible packaging material that provides dimensional stability by resisting stretching and inelastic deformation during refrigerated storage; i.e., a flexible package material useful to produce a flexible package with dimensional stability and a stable interior volume during refrigerated storage, as specified herein. The flexible package material can desirably be of a type that exhibits sufficiently stable mechanical properties to give the flexible package a high level of dimensional stability during refrigerated storage; for example the flexible packaging material can withstand pressure of the pressurized packaged dough product without substantial stretching. Examples of flexible packaging materials that can produce a flexible package having a desired level of dimensional stability include different forms of polyester films (polyethylene terephthalate).

Other package embodiments include the flexible package as an “inner package” that is covered at least partially by an outer package such as an outer tube or an outer wrap placed outside of the (inner) flexible package. The inner package may not necessarily exhibit dimensional stability. The outer package can be used to provide the package with dimensional stability by constraining the volume of (inner) flexible package and its interior volume. In these embodiments, a flexible package (“flexible inner package”) does not require a packaging material that exhibits sufficiently stable mechanical properties to provide dimensional stability during refrigerated storage, especially the ability to not stretch or inelastically deform over time during a refrigerated storage period while containing a raw dough product under pressure. The outer package can be of a material that exhibits sufficiently stable mechanical properties to provide the flexible package with dimensional stability during refrigerated storage. That material of the outer package may be a flexible package material such as a polymeric film, or a different type of not-flexible, relatively more rigid packaging material that, while not required to be flexible, does still provide mechanical properties that result in a dimensionally stable package.

Referring to FIGS. 1A, 1B, and 1C, illustrated is an example of a packaged dough product that includes a flexible package that defines a pressurized and interior volume, and dough contained in the pressurized interior volume. Packaged dough product 10 contains a dough composition in the form of multiple dough products 12, which may be biscuits or other puck-shaped raw dough pieces (as illustrated), located within interior volume 14 of flexible package 16. Interior volume 14 is a size sufficient to contain dough product pieces 12, having a contained raw specific volume below about 1.1 cc/g, with a low amount of headspace.

Flexible package 16 is made of a single piece (alternately multiple pieces) of flexible packaging material, e.g., a polymeric film that is folded over itself along a length of a longitudinal edge of flexible package 16, and is sealed along the opposed longitudinal edge and both ends by seal 24. Seal 24 may be any useful air-tight seal such as an adhesive (e.g., pressure-sensitive adhesive or structural (polymeric, thermoplastic adhesive) between two opposing surfaces of the packaging material), thermobonding, a mechanical closure, a seal or sealant layer of the flexible packaging material film, or the like. The flexible film packaging material of flexible package 16 can exhibit low stretch and low elasticity during a refrigerated storage period, to provide dimensional stability to flexible package 16 during the refrigerated storage period.

As illustrated, packaged dough product 10 exhibits certain features of a packaged dough product as described herein, including one or more of: the raw dough composition (pieces 12) contained in package 16 has a contained raw specific volume in a range from about 0.9 to about 1.1 cc/g; pressurized flexible package 16 has an interior pressure in a range from about 7 to about 20 psig; flexible package 16 has low headspace (e.g., less than 5 percent); and the ratio of the contained raw specific volume of dough composition 12 to the pressure (absolute) is in a range from about 0.012 to about 0.026 cc/g/psia. Flexible package 16 can define interior volume 14 to have length, volume, and aspect ratio as described herein. Flexible package 16 exhibits sufficient dimensional stability such that interior volume 14 does not increase by an amount of more than 10 percent, e.g., not more than 7 percent, during a period of refrigerated storage of the pressurized dough product. As a result, during the refrigerated storage period: the contained raw specific volume of dough composition 12 can remain in a range from about 0.9 to about 1.1 cc/g; the internal pressure of package 16 can remain in the range from about 7 to about 20 psig; and the ratio of the contained raw specific volume to the pressure (absolute) can remain in the range from about 0.012 to about 0.026 cc/g/psia. Preferably, the contained raw dough composition can be released to a desired released raw specific volume (e.g., from about 1.3 to about 1.4 cc/g) and can be baked to a desired baked dough product, e.g., at least 2.7 cc/g.

To produce the desired dimensional stability of flexible package 16, flexible package 16 can be made of a flexible package material that exhibits mechanical properties to achieve that dimensional stability, including the ability to not stretch during a refrigerated storage period while containing the dough composition under pressure as described.

In the embodiment of FIG. 1A, the size of interior volume 14 is about the same as the total volume of the raw dough products 12, at the time that raw dough composition 12 is placed within interior volume 14. As a result, when raw dough composition 12 is placed within interior volume 14 and the package is formed and closed, there is a low amount of headspace within interior volume 14.

Optionally and as illustrated, flexible package 16 includes a pressure release mechanism and opening feature that allows flexible package 16 to be opened quickly to release pressure from dough pieces 12 and allow all of dough pieces 12 to uniformly expand to a released raw specific volume. In specific, seam 20 is shown as a dashed line extending lengthwise between two ends of elongate package 16. As shown at FIGS. 1A (top view) and 1B (end view), release tape 22 extends along the length of package 16 to cover seam 20 and hold seam 20 closed (and under pressure) during refrigerated storage. Release tape 22 can be a flexible adhesive-coated material such as a flexible yet inelastic polymeric (or paper, or fabric, etc.) film or sheet material coated on one side with an adhesive having sufficient adhesion and shear strength to hold flexible package 16 closed, against the internal pressure of package 16. In alternate embodiments, seam 20 and release tape 22 can be located at a different position of flexible package 16, such as adjacent to seal 24 and extending along the length and two ends of flexible package 16.

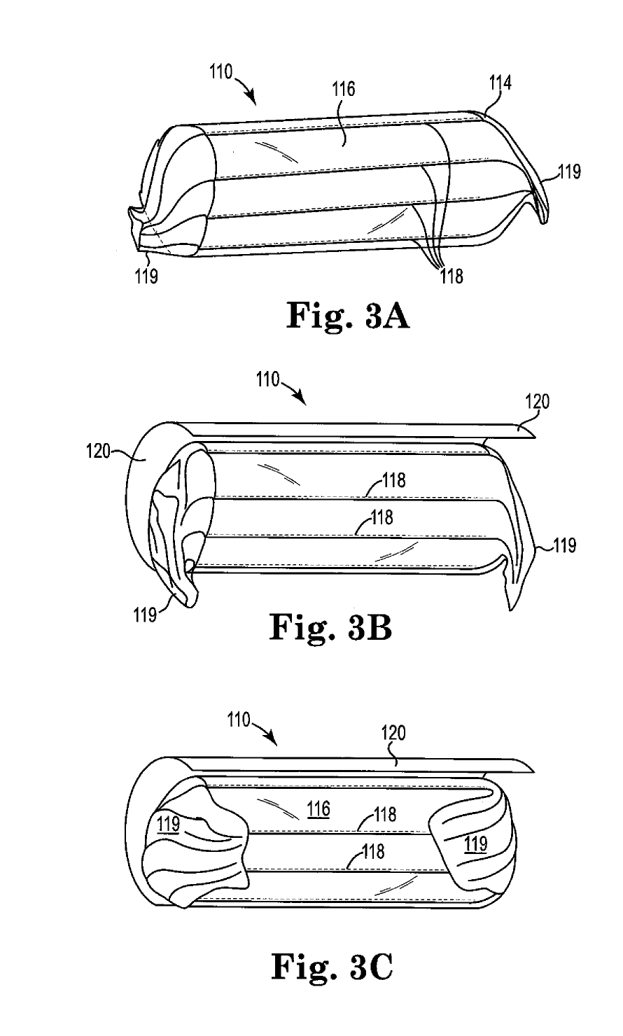

The package embodiment of FIG. 1A is one version of various possible package configurations that can include a flexible package having an interior volume that is formed about a dough composition to be within a few percent of the volume of the contained raw dough (having a raw specific volume between about 0.9 to 1.1 cc/g) at the time that the dough is placed in the package, and wherein the flexible package exhibits desired dimensional stability as described. This configuration type does not include an outer package that serves to constrain the volume of the pressurized flexible package. Other such package embodiments that do not require an outer package are also possible, such as a two-piece package comprising a bottom piece that is thermoformed and a top piece (e.g., a flat cover) that is placed over the bottom piece and sealed about a perimeter on four sides of the package. For example, Assignee's application having U.S. Publication No. 2010/0310732, filed Jun. 9, 2009, by David J. Domingues et al., entitled PRESSURE PACKAGED DOUGH PRODUCTS; and Assignee's application having U.S. Publication No. 2010/0307948, filed Jun. 9, 2009, by David J. Domingues et al., entitled PACKAGING EMPLOYING BOTH SHRINKABLE AND NON-SHRINKABLE FILMS, the entireties of which are incorporated herein by reference, describe two-piece package configurations that could be useful to produce a packaged product as described herein, if prepared from a dimensionally stable material to provide a dimensionally stable interior volume, as described herein, and to also contain a dough at a pressure, raw specific volume, and expansion potential, as described herein. Another such embodiment is shown at FIG. 2 of the present application.

Referring to FIG. 2, packaged dough product 30 contains raw dough product 42 located within interior volume 44 of flexible package 46. Interior volume 44 is of a size sufficient to contain dough product 42, having a contained raw specific volume not greater than about 1.1 cc/g, with a low amount of headspace. Flexible package 46 is made of a single piece of tubular flexible packaging material, e.g., a tubular polymeric film; after dough product 42 has been inserted into interior volume 44, opposing ends 48 of flexible package 46 are folded over against sidewalls along a length of flexible package 46 to close the ends and create interior volume 44. As illustrated, ends 48 can be held against the sidewalls by tape 50 to create an air-tight closure capable of withstanding the internal pressure of the pressurized package. Alternately, other closure mechanisms can also be useful, such as adhesive or rubber or plastic bands placed about a perimeter of flexible package 46 to hold ends 48 against the package sidewalls. As another alternative, ends 48 could be sealed by adhering two opposing surfaces of the film together by adhesive, thermobonding, a mechanical closure, a seal layer of the flexible packaging material film, or the like.

Optionally and as illustrated, flexible package 46 includes a pressure release mechanism and opening feature that allows package 46 to be opened in a manner to uniformly release pressure and dimensional constraints from dough composition 42, to allow dough composition 42 to uniformly expand to a released raw specific volume. Seam 32 is shown as a dashed line extending lengthwise between two ends of interior volume 44. Seam 32 may be an opening and pressure release feature as shown at FIGS. 1A (top view) and 1B (end view), which includes a seam and a seam closure (e.g., tape); alternately, seam 32 may be a cord, wire, thread, string, filament, or polymer strip, or the like, that can be pulled quickly in a longitudinal direction to open package 46 along seam 32 in a manner that quickly and uniformly releases the volumetric constraints that package 46 imparts upon dough composition 42.

Packaged dough product 30 also preferably exhibits certain features of a packaged dough product as described herein, including one or more of: the raw dough composition contained in flexible package 46 has a contained raw specific volume in a range from about 0.9 to about 1.1 cc/g; flexible package 46 has an interior pressure in a range from about 7 to about 20 psig; flexible package 46 has low headspace (e.g., less than 5 percent); and the ratio of the contained raw specific volume to the pressure (absolute) is in a range from about 0.012 to about 0.026 cc/g/psia. Flexible package 46 can define interior volume 44 to have length, volume, and aspect ratio as described herein. Flexible package 46 exhibits sufficient dimensional stability such that interior volume 44 does not increase by more than about 10, e.g., 7 percent during a period of refrigerated storage of the pressurized dough product. As a result, during the refrigerated storage period: the contained raw specific volume of dough composition 42 can remain in a range from about 0.9 to about 1.1 cc/g; the internal pressure of package 46 can remain in the range from about 7 to about 20 psig; and the ratio of the contained raw specific volume to the pressure (absolute) can remain in the range from about 0.012 to about 0.026 cc/g/psia. Preferably, contained raw dough composition 42 can be released to a desired released raw specific volume (e.g., from about 1.3 to about 1.4 cc/g) and can be baked to a desired baked dough product.

To produce the desired dimensional stability of flexible package 46, flexible package 46 can be made of a flexible package material that exhibits mechanical properties to achieve that dimensional stability, including the ability to not stretch during a refrigerated storage period while containing the dough composition under pressure as described.

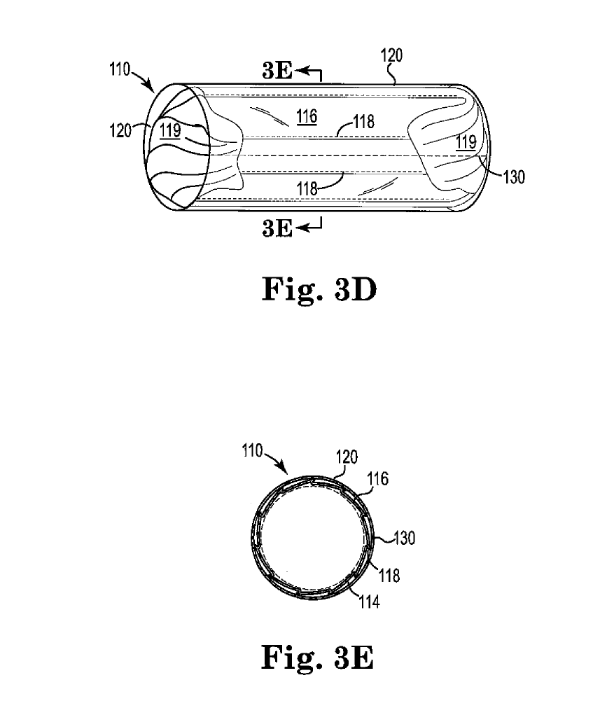

Referring to FIGS. 3A, 3B, 3C, 3D, and 3E, illustrated is an example of an alternate embodiment of a packaged dough product, this example including an inner flexible package that defines a pressurized and interior volume, dough contained in the interior volume, and an outer package in the form of an outer wrap to provide dimensional stability of the interior volume. Packaged dough product 110 contains raw dough composition 112 located within interior volume 114 of inner flexible package 116. Interior volume 114 is sized to contain dough composition 112, having a contained raw specific volume below about 1.1 cc/g, after headspace has been reduced to a low amount, such as to a headspace of not more than 5 percent, less than 2 percent, or less than 1 percent of the total interior volume (114).

Flexible package 116 is optionally made of flexible packaging material, which may be a single piece of material or multiple pieces, e.g., a flexible polymeric film tube. Flexible package 116 is oversized relative to the volume of dough product 112 when dough product 112 is inserted into interior volume 114, meaning that the maximum interior volume (without stretching) of flexible package 116 is at least 5 percent (e.g., 10, 15, or 20 percent or more) greater than the volume of dough composition 112, at the time dough composition 112 is placed inside of package 116. To remove headspace, flexible package 116 can be folded, wrinkled, or otherwise collapsed around the lengthwise perimeter of flexible package 116, as indicated by folds or wrinkles 118 (illustrated as extending longitudinally along a length of flexible package 116). Ends 119 of flexible package 116 can be folded against sidewalls to close each of ends 119 and enclose interior volume 114 in an air-tight manner. Because interior volume 114 is oversized, interior volume 114 will be capable of accommodating a volume of dough that is larger than the volume of dough composition 112 as the dough composition was placed inside of package 116 (which is at an original raw specific volume that is approximately the same as but not in excess of a desired constrained raw specific volume). Accordingly, after a refrigerated storage period during which the amount of carbon dioxide builds within dough composition 112 to increase internal pressure within interior volume 114, the interior volume of flexible package 116 will be capable of expanding to an interior volume that is sufficiently large to contain dough composition 112 at a released raw specific volume, upon de-pressurization after a refrigerated storage period.

In use, dough composition 112, at an original raw specific volume in a range from 0.9 to 1 cc/g. Headspace is removed from flexible package 116, such as by forming wrinkles or folds 118, and ends 119 are closed. During refrigerated storage, the dough may expand somewhat (e.g., less than 10 percent), but because the volume of package 116 is dimensionally stable, and relatively constant, internal pressure within flexible package 116 builds instead of a large volume increase.

Flexible package 116 can be any flexible packaging material, and need not necessarily exhibit mechanical properties (e.g., low stretch properties) that will cause flexible package 116 to exhibit desired dimensional stability properties during refrigerated storage. In this illustrated embodiment, outer package 120 can be placed around flexible package 116 in a manner to apply pressure and effect dimensional (e.g., volumetric) constraints on interior volume 114 of flexible package 116. Outer package 120 is a packaging material (optionally flexible, semi-flexible, semi-rigid, e.g., paper, polymeric, etc.) that is wrapped around an outer surface of flexible package 116 at least one revolution. In use, after wrinkles or folds 118 are formed in (inner) flexible package 116 (see FIG. 3A), ends 119 of flexible package 116 can be folded against sidewalls of flexible package 116, as in FIGS. 3B and 3C. Outer package 120 can be wrapped around flexible (inner) package 116. Folded ends 119 are securely held between the sidewalls of flexible package 116 and the inner surface of outer package 120, as shown in FIGS. 3C and 3D; in these secured positions, folded ends 119 produce air-tight seals of interior volume 114 that are capable of withstanding internal pressures experienced during refrigerated storage. Simultaneously, ends 119 prevent the volume of interior volume 114 from increasing in a length-wise direction during refrigerated storage. Outer package 120 imparts dimensional stability upon interior volume 114 in at least the two dimensions of the cross section of interior volume 114 (width and height), while dimension stability in a third (lengthwise) direction occurs by folded ends 119 preventing expansion of dough 112 in the lengthwise direction.

Packaged dough product 110 can exhibit certain features of a packaged dough product as described herein, including one or more of: the raw dough composition 112 contained in inner flexible package 116 has a contained raw specific volume in a range from about 0.9 to about 1.1 cc/g (e.g., when placed inside of flexible package 116, then during a refrigerated storage period); inner flexible package 116 has an interior pressure in a range from about 7 to about 20 psig; inner flexible package 116 has low headspace (e.g., less than 5 percent); and the ratio of the contained raw specific volume to the pressure (absolute) is in a range from about 0.012 to about 0.026 cc/g/psia. Flexible package 116 can define interior volume 114 to have length, volume, and aspect ratio as described herein. Outer package 120 exhibits sufficient dimensional stability such that interior volume 114 (constrained by outer package 120 in at least two dimensions, and also constrained by ends 119 being secured to sidewalls of package 116 as illustrated) does not increase by an amount of more than about 10 or about 7 percent during a period of refrigerated storage. During the refrigerated storage period: the contained raw specific volume of dough composition 112 can remain in a range from about 0.9 to about 1.1 cc/g; the internal pressure of inner flexible package 116 can remain in the range from about 7 to about 20 psig; and the ratio of the contained raw specific volume to the pressure (absolute) can remain in the range from about 0.012 to about 0.026 cc/g/psia. Preferably, the contained raw dough composition can be released to a desired released raw specific volume (e.g., from about 1.3 to about 1.4 cc/g) and can be baked to a desired baked dough product.

To produce the desired dimensional stability of inner flexible package 116, outer package 120 can be made of a packaging material (flexible or otherwise) that exhibits mechanical properties to achieve that dimensional stability, including the ability to not stretch during a refrigerated storage period while containing the dough composition under pressure as described. Outer package 120 may be flexible, semi-flexible (semi-rigid), or rigid, and can be made of any packaging material that will not substantially stretch or deform during refrigerated storage, and that will, therefore, prevent raw dough composition 112 from expanding by more than 7 percent during a refrigerated storage period. Examples of polymeric film materials that may be suitable for outer package 120 include dimensionally stable flexible packaging material as described, that prevent the dough pieces 12 from increasing in volume by more than about 7 percent during a period of refrigerated storage. Examples of relatively more rigid materials that can be useful as an outer package 120 in the form of a wrap include higher thickness polymeric materials, cardboard, paper, and the like.

Optionally and as illustrated outer package 120 can include a pressure release mechanism 130 that allows outer package 120 to be opened in a manner to uniformly and quickly release pressure and volumetric constraints from inner flexible package 116, and to allow dough composition 112 to uniformly expand to a released raw specific volume. The pressure release mechanism can remove the dimensional constraints that outer package 120 applies to inner flexible package 116, but does not necessarily and is not required to also open inner flexible package 116 to allow removal of dough composition 112 from interior space 114. Release of the dimensional constraints that outer package 120 imparts upon inner package 116 can allow expansion of dough composition 112 (e.g. to a released raw specific volume) within oversized inner flexible package 116, which, due to its being oversized, can accommodate that expansion by unfolding along wrinkles 118, thereby increasing the size if interior volume 114. After outer package 120 is subsequently removed from the outside of inner flexible package 116, inner flexible package 116 can be opened and dough composition 112 can be removed from interior volume 114. Pressure release mechanism 130 can be a pressure release mechanism as described herein, such as a tape that covers a seam or perforation, or a cord, wire, filament, etc., either of which can be pulled along a length of outer package 120 to produce a longitudinal opening along a length of outer package 120, releasing pressure that outer package 120 held about inner flexible package 116 and dough composition 112 contained in interior space 114.

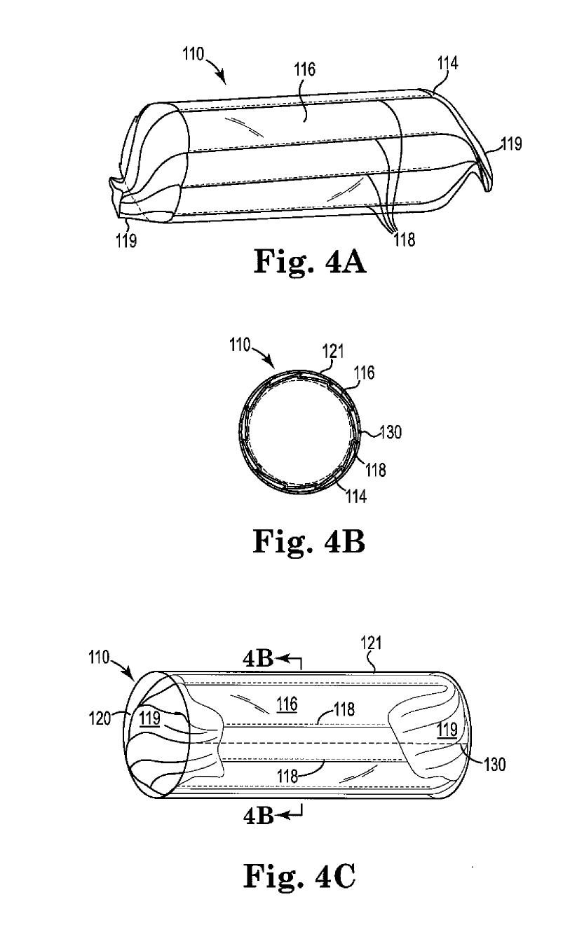

Referring to FIGS. 4A, 4B, and 4C, illustrated is an example of an alternate embodiment of a packaged dough product as shown at FIGS. 3A through 3E, this embodiment including an outer package 121 in the form of a semi-rigid cardboard tube, as a replacement for outer package 120 in the form of a flexible wrap. All other features and performance of product 110 of FIGS. 4A through 4C are the same as those described for product 110 of FIGS. 3A through 3E.

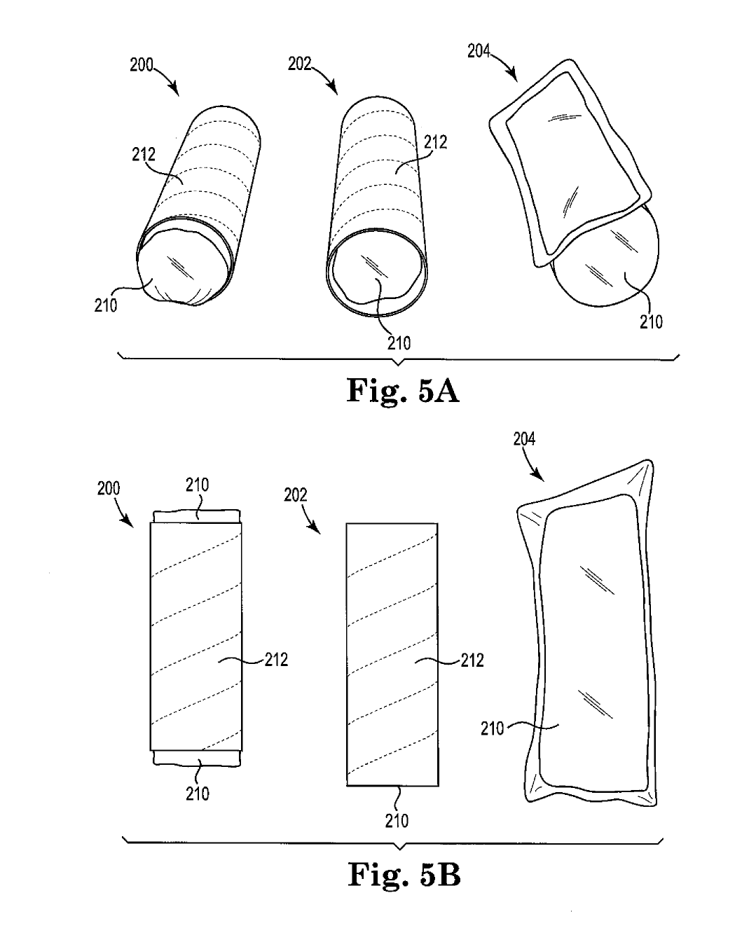

Still other embodiments of packages that include an inner flexible pressurized package and an outer package to provide dimensional stability are understood. FIGS. 5A and 5B show top and side perspective views of two different versions of two-piece packages (200, 202) that include an inner flexible package 210 and an outer rigid or semi-rigid package 212 in the form of a cardboard tube. A third package 204 shows the inner flexible package with no outer package. Inner flexible package 210 can be made of a flexible polymer film as described, which does not exhibit dimensional stability such as a low stretch property. As illustrated, inner flexible package 210 is of a two-piece construction; a first bottom piece includes a thermo-formed cavity and an opening at the top, with a perimeter about the cavity; a second top piece is placed over the opening and in contact with the perimeter of the bottom piece, and the second top piece is sealed to the perimeter. Examples of useful films for the inner package include polyethylene, polypropylene, polyester, nylon, and the like, which may or may not exhibit desired dimensional stability as described. With packages 200 and 202, the ends of inner flexible package 210 of packages are folded back along the sidewalls of the inner flexible package 210 and held securely between the sidewall of inner flexible package 21 and the inner surface of the cylindrical outer package 212.

FIGS. 5A and 5B show outer packages 212 in the form of rigid or semi-rigid dimensionally stable (e.g., stretch resistant) cardboard (alternately plastic) tubes each tube having a different length. The length of the cardboard tube of FIG. 5A is about 15.3 centimeters, which is slightly less than the length of the inner flexible package 210. The length of the cardboard tube of FIG. 5B is about 18 centimeters, which is slightly greater than the length of the inner flexible package 210. In each instance, with package 200 and 202, the interior volume and pressure of the inner package were contained to cause the package to maintain an expansion potential as desired, and as described herein. Package 204, in contrast, lacking the volumetric constraint of an outer package 212, experienced expansion and a change in volume, likely a reduction in pressure, and would not have maintained an expansion potential as desired and described herein.

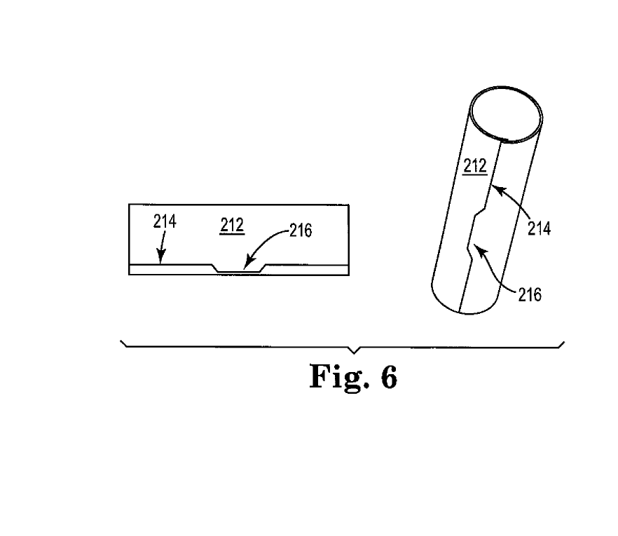

FIG. 6 shows yet an alternative outer package that is dimensionally stable and can be used to provide dimensional stability to an interior volume of a flexible inner package. Cylindrical cardboard or plastic tube package 212 can be used as an outer package 212 as shown in FIGS. 5A and 5B, and as otherwise described herein, in a manner to contain a flexible inner package (e.g., 210 at FIGS. 5A and 5B), and can provide dimensional stability of a packaged product during a refrigerated storage period. Opposing ends of cylindrical tube package 212 are open, so ends of the inner flexible package 210 may optionally be folded and held between a sidewall of the inner flexible package 210 and outer package 212 of FIG. 6. A useful feature of cylindrical tube package 212 of FIG. 6 is longitudinal release 214, which is a longitudinal overlapping seam between an outer surface of cylindrical tube and an opposing, overlapping inner surface. Longitudinal release 214 is held together by adhesive between the overlapping surfaces. In use, a flexible inner package 210 (not shown) can be placed within outer cylindrical tube package 212, with dough at an original volume in a range from 0.9 to 1.1 cc/g. Optionally the flexible inner package can be oversized, and headspace can be removed by collapsing the excess volume against the contained dough composition. The outer diameter of the inner flexible package is slightly less than the inner diameter of cylinder tube package 212 upon placement of the flexible package within the outer package 212, and the outer diameter of the inner flexible package 210 expands slightly after placement to produce a snug fit between the inner flexible package 210 and the outer package 212 (see FIGS. 5A and 5B). During refrigerated storage, pressure will build within the inner flexible package, but volume of the inner flexible package will be constrained by outer package 212. Upon use by a consumer, outer package 212 can be easily an quickly removed by separating outer package 212 along longitudinal release 214, e.g., by pulling tab 216, allowing for rapid and uniform expansion of the dough contents within the (optionally oversized) inner flexible package.

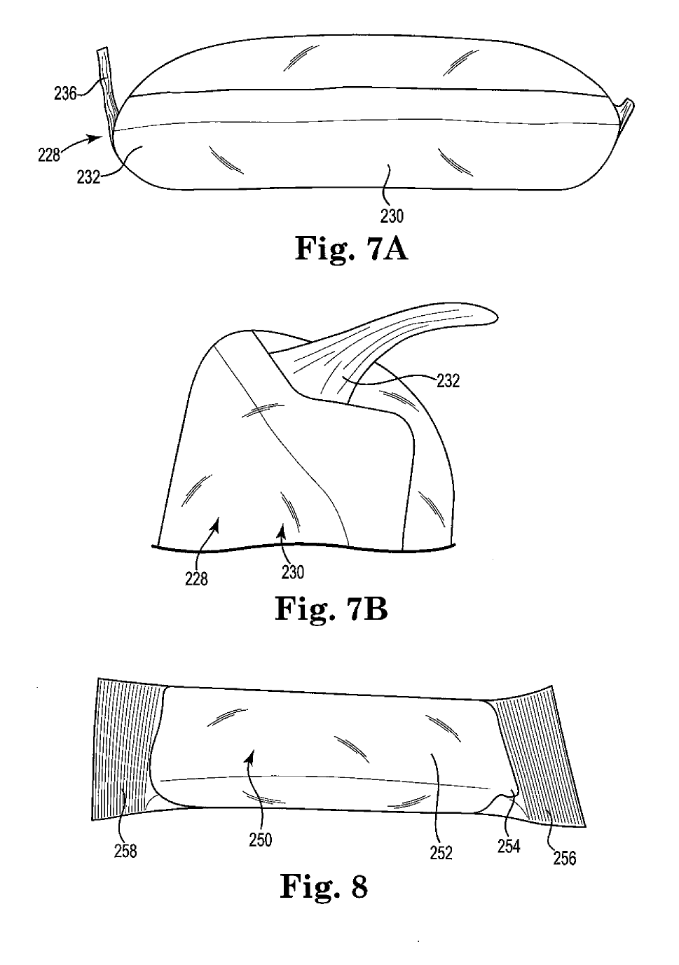

FIGS. 7A and 7B show an alternate package embodiment that contains an inner flexible package 230 and outer dimensionally stable package 232. As illustrated, inner flexible package 230 is of a two-piece construction, such as according to the embodiment at FIGS. 5A and 5B. Outer package 232 is in the form of a flexible dimensionally stable (e.g., stretch resistant) shrinkable (“shrink-wrap) film, which more particularly can be in the form of a shrink-wrapped tube that is placed to extend over and around inner flexible package 230, then heated to a reduced volume. After heat shrinking, outer dimensionally stable package 232 includes two open (unsealed) ends 236 and 238, which cover sealed and closed ends of inner flexible package 230. The length of outer dimensionally stable flexible package 232 is greater than the length of inner flexible package 230. During use, the interior volume and pressure of inner package 230 is contained by the dimensionally stable outer package 232, to cause inner flexible package 230 to maintain an expansion potential as desired and as described herein.

FIG. 8 shows an otherwise similar two-piece packaged product 250, of inner flexible package 252 and outer dimensionally stable package 254. According to this embodiment, inner flexible package 252 can be as described and exemplified herein. Outer dimensionally stable package 254, as illustrated, is a form flow wrapped and sealed outer package made of, e.g., polyester. Advantageously, the form-flow wrapped outer film 254 is of a type of outer package that can be produced by a continuous manufacturing process, by wrapping the polymeric film about inner flexible package 252, sealing and cutting a first end 256, sealing and cutting a second end 258, and sealing a longitudinal seam (not shown), in a manner such that the volume of the outer flow wrap package 254 approximates the volume of inner flexible package 252, allowing for only a controlled or minimized amount of expansion of inner package 252 after placement and formation of outer package 254 at the exterior of inner flexible package 252. The dimensionally stable outer package 254 constrains the volume of inner flexible package 252, and prevents undue expansion of inner flexible package 252. The interior volume and pressure of inner package 252 can be contained to cause the package to maintain an expansion potential as desired, and as described herein.

A two-piece packages that includes an inner flexible package and an outer package in the form of a dimensionally stable tube (see., e.g., FIGS. 5A and 5B) can be assembled in a manner by which the inner flexible package is placed within the tubular outer package, then expands slightly in volume to fit snugly within the tubular outer package. The inner flexible package can be assembled by placing a dough composition having an original raw specific volume in a range from about 0.9 to 1.1 cc/g into the inner flexible package, with the outer dimensions (e.g., diameter) of the inner flexible package being not greater than and optionally slightly less than the inner diameter of the tubular outer package. As an example, the inner diameter of the tubular outer package may be larger than the outer diameter of the inner flexible package, by no more than about 3 percent, 2 percent, or 1 percent, at the time of assembling the inner flexible package to contain the raw dough composition. The slightly smaller diameter or approximately equal diameter of the inner flexible package allows the inner flexible package to be inserted into the space defined by the outer package tube. After placement within the inner package, the volume of the packaged dough will expand slightly, causing the diameter of the inner flexible package to increase slightly after being placed within the outer package tube. A slight increase in the volume of the dough can provide a sufficient increase in the outer dimension of the inner flexible package, e.g., 0.5 percent, 1, 2, or 5 percent, to cause the inner flexible package to expand slightly and fit snugly and securely within the outer package. The dimensional stability of the outer package will thereafter prevent further volumetric expansion of the inner flexible package, at least in the two cross-sectional dimensions (height and width). The ends of the inner flexible package can optionally secured and held in place to prevent length-wise expansion, if desired or necessary.

According to other described package embodiments, wherein the outer package is a dimensionally stable form flow package (see FIG. 8), a dimensionally stable polymeric or cardboard wrappable outer package (see FIG. 7), or a heat-shrinkable tube (see FIGS. 7A and 7B), a dimensionally stable outer package can be formed about an inner flexible package in a manner by which the outer package is wrapped, formed, or heat-shrunk about the inner flexible package, and by which dimensions of the outer package approximate the dimensions of the inner package to produce a close and tight fit of the outer package around the inner package as the outer package is being formed about the inner package.

Dough compositions of the packaged refrigerated dough product are chemically leavened and can include useful ingredients such as flour, water, optional fat and optional sweetener, optional yeast (e.g., for flavoring), and chemical leavening agents that include an acidic chemical leavening agent and a basic chemical leavening agent.

Acidic chemical leavening agents are known in the dough and bread-making arts, with examples including sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dihydrate (DCPD), glucono-delta-lactone (GDL), as well as a variety of others. Acidic chemical leavening agents come in a variety of solubilities at different temperature ranges, and may be either encapsulated or non-encapsulated. Commercially available acidic chemical leavening agents include those sold under the trade names: Levn-Lite® (SALP), Pan-O-Lite® (SALP-FMCP), STABIL-9® (SALP+AMCP), PY-RAN® (AMCP), and HT® MCP (MCP).

Acidic chemical leavening agents that are considered to be of relatively high solubility include agents that are soluble in a liquid (e.g., aqueous) component of a dough composition at a temperature used during processing (e.g., from 40 to about 72 degrees Fahrenheit) or at a refrigerated storage temperature (e.g. from about 32 to about 55 degrees Fahrenheit). Examples of such soluble acidic chemical leavening agents include glucono-delta-lactone and sodium acid pyrophosphate (SAPP) of a moderate to high solubility e.g., SAPP 60, SAPP 80, as well as other acidic chemical leavening agents that exhibit similar solubility behavior.

Other acidic chemical leavening agents are only slightly s at leastoluble (e.g., are insoluble) at processing and refrigerated temperatures, e.g., are only slightly soluble in an aqueous component of a dough composition at processing and refrigerated storage temperatures. Such insoluble acidic chemical leavening agents can be included in a dough composition to remain relatively insoluble and therefore relatively inactive during processing, packaging, and storage of a dough composition, and then to become dissolved in a dough composition at a temperature experienced during cooking, such that with a basic agent to produce carbon dioxide during cooking. Examples of useful insoluble acidic chemical leavening agents include SALP and relatively slower reacting SAPP (e.g., low activity SAPP, for example SAPP-RD-1, 26, 28), as well as other acidic agents that exhibit solubility behavior similar to SALP and low activity SAPP.

Certain embodiments of dough compositions as described can include one or multiple types of acidic chemical leavening agent, for selected activity at different temperatures that occur during processing and cooking of the dough composition. For example, a single relatively soluble acidic agent such as soluble SAPP may be present in a dough composition. Alternately a combination of two or more soluble acidic agents can be included in a dough composition. According to yet other embodiments, a dough composition may include a combination of two or more acidic chemical leavening agents having different activity levels, e.g., one acidic agent that is of high solubility (at processing temperatures) that dissolves to a sufficient degree during processing to react with a basic agent to produce carbon dioxide, and another that is sufficiently insoluble to not dissolve or react at processing, packaging, or refrigerated storage temperatures.

Examples of acidic chemical leavening agents that can be active at a processing temperature include monosodium phosphate, monocalcium phosphate monohydrate (MCP), anhydrous monocalcium phosphate (AMCP), dicalcium phosphate dihydrate (DCPD), glucono-delta-lactone (GDL), SAPP 60, SAPP 80, etc., normally but not necessarily in a non-encapsulated form. A low solubility acidic agent can be as discussed above, e.g., SALP or low activity SAPP, or a combination of two or more low activity acidic agents. In specific embodiments, a combination of soluble and insoluble acidic chemical leavening agents can be used in combination with a single type of basic agent, such as a free or encapsulated soda, such that the soluble acid and base react to produce carbon dioxide at processing temperature, and the insoluble acid and base react to produce carbon dioxide at a cooking temperature.

The amount of total acidic chemical leavening agent included in a dough composition can be an amount sufficient to neutralize a total amount of basic chemical leavening agent in the dough composition, e.g., an amount that is stoichiometric to the total amount of basic chemical leavening agent, with exact amounts being dependent on the particular basic and acidic chemical leavening agents. A typical amount of total acidic chemical leavening agent such as SALP, SAPP, GDL, or combinations of SALP SAPP, GDL, or another, may be in the range from about 0.25 to about 3 weight percent based on the total weight of a dough composition, e.g., from about 0.25 to about 1.5 weight percent based on the total weight of the dough composition.

For dough compositions that include two types of acidic agents, such as a soluble acidic leavening agent in combination with an insoluble acidic leavening agent, these can each be present to produce desired carbon dioxide evolution during processing (e.g., packaging) and during cooking. An amount of soluble acidic chemical leavening agent can be an amount in the range from 0.25 to 2 weight percent relatively soluble acidic chemical leavening agent, based on the total weight of a dough composition. An amount of insoluble acidic chemical leavening agent (i.e., insoluble in a dough composition at 40 to 72 Fahrenheit) can be an amount in the range from 0.1 to 2 weight percent relatively insoluble acidic chemical leavening agent, based on the total weight of a dough composition.

Useful basic chemical leavening agents are generally known in the dough and baking arts and include soda, i.e., sodium bicarbonate (NaHCO₃), potassium bicarbonate (KHCO₃), ammonium bicarbonate (NH₄HCO₃), etc. The basic agent may be encapsulated or non-encapsulated. Both encapsulated and non-encapsulated basic chemical leavening agents are generally known and commercially available, and can be prepared by methods known in the baking and encapsulation arts. Optionally, a dough compositions can contain either a single or multiple different types of basic agent, either a single type of basic agent or single degree of encapsulation, or a combination of basic agents having different degrees of encapsulation e.g., from non-encapsulated “free” soda, to encapsulated soda of varying degrees of encapsulation and activity.

In addition to specific chemistries, encapsulated basic chemical leavening agents can be characterized based on their “activity,” which refers to the percentage by weight of active basic agent that is contained in encapsulated particles, based on the total weight of active basic agent and encapsulating material that make up the particles. According to the invention, useful activities of an encapsulated basic chemical leavening agent can be any activity that provides a desired amount of exposure of the basic agent to a dough composition either during processing or during baking. Examples of useful activities can be, e.g., at least 30 percent, 50 percent, 60 percent, 70 or 75 percent.

The total amount of basic chemical leavening agent that may be included in a dough composition can be any useful or desired amount, e.g., an amount sufficient to react with a total amount of acidic chemical leavening agent to release a desired amount of carbon dioxide gas for leavening at the various stages of packaging, refrigerated storage, and cooking. Desirably, the basic agent (in combination with one or a combination of acidic agents) can result in sufficient reactivity with the acidic agent, to produce carbon dioxide during processing and packaging to cause a package to become pressurized inside of the flexible package and to achieve a desired “expansion potential.” Also desirably, the amount of carbon dioxide production and dough expansion during refrigerated storage are controlled to prevent excessive build of internal pressure and to prevent bursting of the packaged dough during refrigerated storage. Also, a desired amount of basic agent (e.g., encapsulated basic agent), and acidic agent, become active during cooking to produce carbon dioxide.

Exemplary amounts of basic chemical leavening agent (not including the weight of any encapsulating material) may be any amount that will produce a pressurized packaged product as described, with useful amounts being in the range from about 0.5 to about 1 weight percent based on total weight of a dough composition, e.g., from about 0.6 or 0.64 to about 0.9 weight percent based on the total weight of the dough composition.

The chemically leavened dough composition can be any of various different types of dough compositions that are often sold commercially. Sometimes different dough compositions can be classified into developed or non-developed doughs. The degree of development of a dough (as in a “developed” versus a “non-developed” dough) generally refers to the strength of a dough's matrix, as the strength relates to the degree of development of gluten (protein) in a dough matrix. During processing of a dough composition, gluten can be caused or allowed to interact or react and “develop” a dough composition in a way that increases the stiffness, strength, and elasticity of the dough. Doughs commonly referred to as “developed” doughs are generally understood to include doughs that have a relatively highly-developed gluten matrix structure; a stiff, elastic rheology; and (due to the stiff, elastic matrix) are well able to form bubbles or cells that can stretch without breaking to hold a leavening gas while the dough expands, leavens, or rises, prior to or during cooking (e.g., baking). Features that are sometimes associated with a developed dough, in addition to a stiff, elastic rheology, include a liquid content, e.g., water content, that is relatively high compared to non-developed doughs; a sufficient (e.g., relatively high) protein content to allow for a highly-developed structure; optionally, processing steps that include time to allow the dough ingredients (e.g., gluten) to interact and “develop” to strengthen the dough; and on average a baked specific volume that is relatively higher than non-developed doughs. Oftentimes, developed doughs are yeast-leavened, but may be chemically leavened. Examples of specific types of doughs that can be considered to be developed doughs include doughs for pizza crust, breads (loaves, dinner rolls, baguettes, bread sticks), raised donuts, cinnamon rolls, croissants, Danishes, pretzels, etc.

As compared to “developed” doughs, doughs commonly referred to as non-developed doughs (or “un-developed” or “under-developed”) have a relatively less developed (“undeveloped”) dough matrix that gives the dough a relatively non-elastic rheology, reduced strength, and reduced gas-holding capacity. Being less elastic than a developed dough and exhibiting a reduced gas-holding capacity, non-developed doughs, on average, exhibit relatively lower raw and baked specific volumes. Examples of non-developed types of dough compositions include cake doughnuts, muffins, biscuits (e.g., soda biscuits), and the like.

A chemically-leavened dough composition according to the invention can include chemical leavening agents as described herein, along with other dough ingredients as known in the dough and baking arts, or as developed in the future to be useful with chemically-leavened dough compositions.

A flour component can be any suitable flour or combination of flours, including glutenous and nonglutenous flours, and combinations thereof. The flour or flours can be whole grain flour, flour with the bran and/or germ removed, or combinations thereof. Typically, a dough composition can include between about 30 and about 50 weight percent flour, e.g., from about 35 to about 45 weight percent flour, based on the total weight of a dough composition.

Examples of liquid components include water, milk, eggs, and oil, or any combination of these, as will be understood to be useful in chemically-leavened, non-developed dough compositions. For example, a liquid component may be water (added as an ingredient and as part of other ingredients), e.g., in an amount in the range from about 15 to 35 weight percent, e.g., from 25 to 35 weight percent, although amounts outside of this range may also be useful. Water may be added during processing in the form of ice, to control the dough temperature in-process; the amount of any such water used is included in the amount of liquid components. The amount of liquid components included in any particular dough composition can depend on a variety of factors including the desired moisture content of the dough composition.

A dough composition can optionally include fat ingredients such as oils and shortenings. Examples of suitable oils include soybean oil, corn oil, canola oil, sunflower oil, and other vegetable oils. Examples of suitable shortenings include animal fats and hydrogenated vegetable oils. Fat may be used in an amount less than about 20 percent by weight, often in a range from 5 or 10 weight percent to 20 weight percent fat, based on total weight of a dough composition.

A dough composition can optionally include one or more sweeteners, either natural or artificial, liquid or dry. Examples of suitable dry sweeteners include lactose, sucrose, fructose, dextrose, maltose, corresponding sugar alcohols, and mixtures thereof.

Dough compositions described herein can be prepared according to methods and steps that are known in the dough and dough product arts. These can include steps of mixing or blending ingredients, folding, lapping, forming, shaping, cutting, rolling, filling, etc., which are steps well known in the dough and baking arts.

The above description includes specific embodiments of the present invention, and is not to be limited to any particular composition or combination of features. As will be understood by those of skill, other embodiments of this invention will be apparent upon consideration of this specification or from practice of the invention disclosed herein. Various omissions, modifications, and changes to the principles and embodiments described herein may be made by one skilled in the art without departing from the scope and spirit of the invention which is indicated by the following claims.

### EXAMPLES

Four example dough formulations were prepared and placed in packages as described below.

The four different packaged dough products included a combination of two different pouch materials (“foil” and “plastic”), and two different levels of basic chemical leavening agent (0.974 weight percent, and 0.731 weight percent). The same heat-shrinkable sleeve was included with each of the four packages.

The four different packages were made with a two-piece construction, including an inner flexible (primary) package that contained a raw dough composition within an interior volume, and an outer (secondary) shrink-wrap sleeve placed about the inner package.

The “foil” package was made of a metalized film with gas barrier properties.

The “plastic” package was made of low gas barrier properties.

The shrink-wrap sleeve for each package was un-perforated PETG Pure Affinia 50 micron (2 mil) thick shrink-wrap film with good dimensional stability as described.

All primary packages had low headspace and were closed sufficiently to maintain elevated pressures during extended refrigerated storage periods.

Example 1 (represented as the diamond) was a dough composition packaged in the foil primary (inner flexible) package, and having the higher level of basic chemical leavening agent.

Example 2 (represented as the square) was a dough composition packaged in the plastic primary package, and having the higher level of basic chemical leavening agent.

Example 3 (represented as the triangle) was a dough composition packaged in the foil primary package, and having the reduced level of basic chemical leavening agent.

Example 4 (represented as the “X”) was a dough composition packaged in the plastic primary package, and having the reduced level of basic chemical leavening agent.

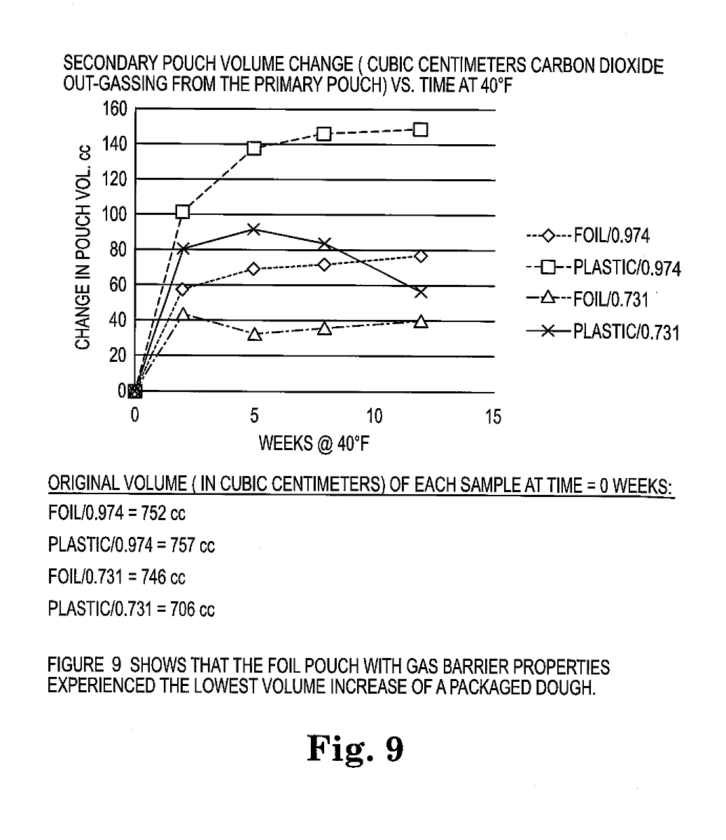

Referring to the tables at FIGS. 9 through 12 the four packaged dough compositions were stored with refrigeration and monitored for: change in pouch volume during periods of refrigerated storage; change in the specific volume of the contained dough (within the pressurized package) during periods of refrigerated storage; storage stability in terms of baked specific volume over periods of refrigerated storage; and “Expansion Potential” over periods of refrigerated storage.

Referring to FIG. 9, for a given primary pouch material (plastic or metalized film), higher soda levels resulted in greater secondary pouch expansion (total package). Additionally, the presence of a gas barrier primary film (metalized film) resulted in less secondary pouch expansion. The low soda with metalized pouch sample set experienced the least amount of secondary pouch expansion, whereas the high soda and plastic (non-gas barrier) film pouch experienced the greatest amount of secondary pouch expansion. Roughly speaking, for a given primary pouch material system, increasing the percent soda from 0.731 weight percent to 0.974 weight percent resulted in an approximate doubling in the extent of secondary pouch expansion. Likewise, going from metalized constructed pouch to thermal formed plastic film pouch resulted in an approximate doubling in secondary pouch expansion volume (for a fixed amount of soda).

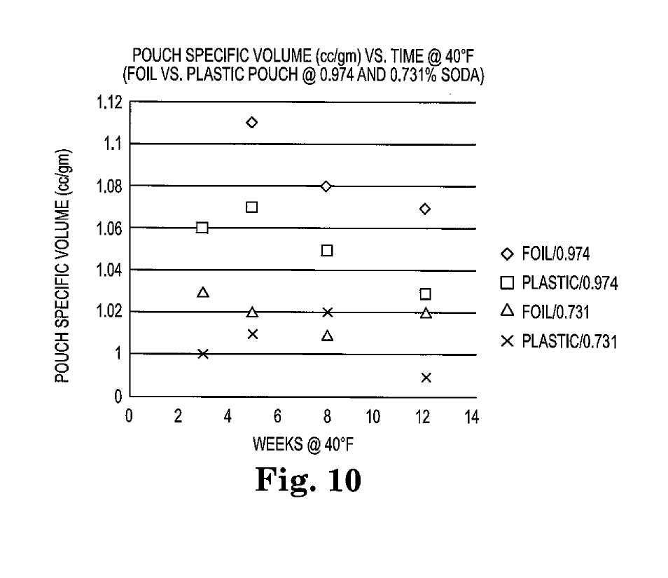

Referring to FIG. 10, pouch specific volumes (PSV) (aka “contained” specific volumes of dough as measured within the package) for the higher soda sample sets were generally higher compared to the lower soda sample sets. Range in PSV as ^{˜}1-1.1 cc/gm (fairly consistent). Maintaining a low and consistent PSV is important to product bake performance (dough needs to expand upon opening (not before opening) for optimal bake performance—avoid collapse and low volume).

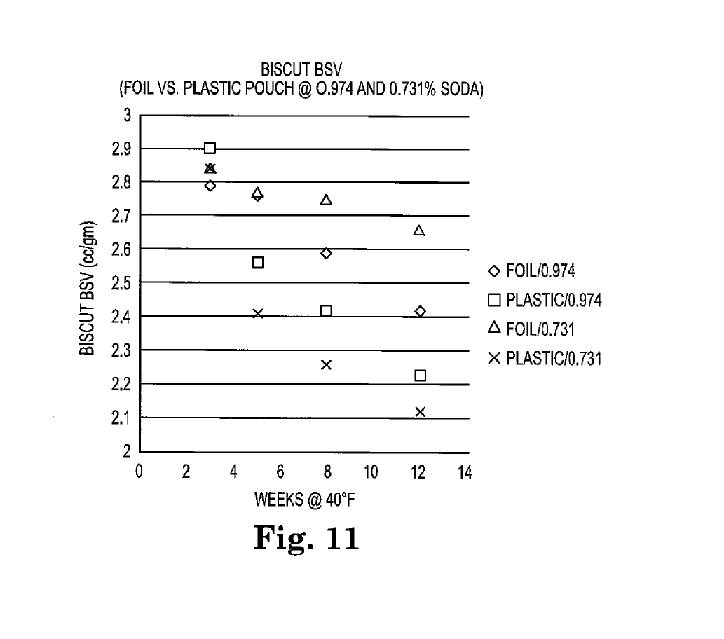

Referring to FIG. 11, the metalized (aka foil) gas barrier film (e.g., high barrier film) pouch and lower amount of basic leavening ingredient sample set resulted in the most stable BSV vs. shelf life time (least amount of decline). The metalized film provides a superior barrier to carbon dioxide diffusion and the lower leavening level (lower amount of basic chemical leavening agent) resulted in the least amount of internal pressure and possessed a low packaged (contained) specific volume (<1.1 cc/gm). The higher leavening level foil pouch sample set experienced a greater decline in BSV over time as compared to the lower leavening level, possibly due to excessively rapid expansion upon opening and loss of gluten matrix integrity and gas holding capability. The lower barrier thermally formed plastic pouches experience the greatest decline in BSV vs. shelf life time, as the plastic film experiences the greatest amount of carbon dioxide diffusion and package expansion. Additionally, the ingress of oxygen through the lower barrier plastic film resulted in excessive glucose oxidase activity which, in all likelihood, adversely affected dough rheological and gas holding properties (observed syneresis/syrupping and yellow discoloration).

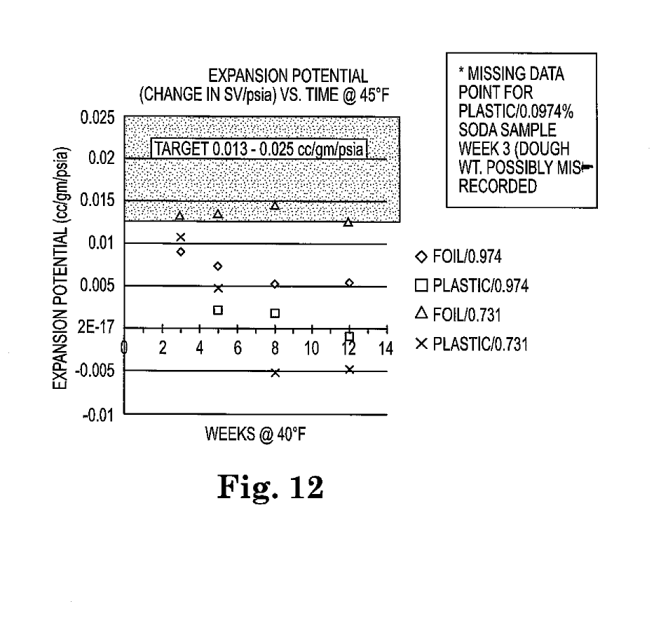

FIG. 12 shows that the Example 3 product held an expansion potential within a target range over various refrigerated storage periods, while the other examples did not.

1. A refrigerated packaged dough product comprising a chemically leavened dough composition inside a pressurized package, the packaged dough product comprising a flexible package defining an interior volume, with the dough composition located in the interior volume, wherein
the dough composition has a contained raw specific volume of from about 0.9 to about 1.1 cubic centimeters per gram measured within the flexible package,
the flexible package contains less than 2 percent headspace and has an internal pressure of from 7 to 20 pounds per square inch (gauge); and
the ratio of the contained raw specific volume to the pressure (absolute) is in a range from about 0.012 to about 0.026 cubic centimeters per gram per pound per square inch (absolute).

2. A dough product as recited at claim 1 wherein the dough composition, when removed from the flexible package, has a released raw specific volume of from about 1.3 to about 1.4 cubic centimeters per gram as measured when removed from the package.

3. A dough product as recited at claim 1, wherein the dough composition comprises from about 0.65 to about 0.9 weight percent basic chemical leavening agent, from 0.25 to 3 weight percent acidic chemical leavening agent, or both.

4. A dough product as recited at claim 1, wherein the flexible film exhibits an oxygen transmission rate below about 20 cubic centimeters per 100 square inches/day at 73° F.

5. A dough product as recited at claim 1 wherein the dough composition has a contained raw specific volume of from 0.95 to 1.1 cubic centimeters per gram as measured within the package.

6. A dough product as recited at claim 1 wherein the flexible package has an internal pressure of from 10 to 15 pounds per square inch (gauge).

7. A dough product as recited at claim 1 wherein the ratio of the contained raw specific volume to the pressure (absolute) is in a range from about 0.012 to about 0.026 cubic centimeters per gram per pound per square inch (absolute), after a refrigerated storage period of 4 weeks, 8 weeks, or 12 weeks.

8. A dough product as recited at claim 1 wherein the dough product can be stored for a refrigerated storage period of at least 4 weeks, and from the time the dough composition is placed in the flexible package, through the refrigerated storage period, the interior volume does not increase by more than 10 percent.

9. A dough product as recited at claim 1 wherein the package comprises a flexible packaging material that exhibits dimensional stability sufficient to prevent the interior volume from increasing by more than about 7 percent during a refrigerated storage period of 12 weeks.

10. A dough product as recited at claim 1 wherein ends of the flexible package are closed by folding the ends against sidewalls of the flexible package.

11-13. (canceled)

14. A dough product as recited at claim 1 wherein the package comprises a mechanism capable of de-pressurizing the interior volume sufficiently rapidly to allow the dough in the interior volume to expand uniformly to a uniform released raw specific volume.

15. A method of preparing a packaged dough product comprising a chemically leavened dough composition inside a pressurized package, the method comprising:
providing a chemically leavened raw dough composition,
providing a flexible package defining an interior volume,
placing the raw dough composition in the interior volume with the interior volume containing less than 2 percent headspace, while the dough composition has a raw specific volume of from about 0.9 to 1.1 cubic centimeters per gram, and
storing the packaged raw dough at refrigerated storage conditions for a refrigerated storage period of at least 2 weeks,
wherein, during the refrigerated storage period:
the package has an internal pressure of from 7 to 20 pounds per square inch (gauge); and
the ratio of the contained raw specific volume to the pressure (absolute) is in a range from about 0.012 to about 0.026 cubic centimeters per gram per pound per square inch (absolute).

16. A method as recited at claim 15 wherein the interior volume is greater than a volume of the raw dough composition, and the method comprises removing headspace from the flexible package to reduce the headspace to below 2 percent.

17. A method as recited at claim 15 comprising, after placing the raw dough composition in the interior volume, with headspace below 2 percent, providing an outer package comprising two ends and an outer package volume between the ends, and placing the inner flexible package at least partially within the outer package volume.

18. A method as recited at claim 17 wherein,
during placing the inner flexible package at least partially within the outer package volume, the inner flexible package has a diameter, the outer package has a diameter, and the outer package diameter is greater than the inner package diameter, and
the method comprises allowing the inner flexible package to expand within the outer package to the diameter of the outer package.

19. (canceled)

20. A method as recited at claim 17 comprising, after the refrigerated storage period, opening the outer package to de-pressurize the dough in the interior volume and allow the dough to expand within the flexible package.

21. A method as recited at claim 20 wherein the outer package is opened sufficiently rapidly to allow the dough in the interior volume to expand uniformly to a uniform released raw specific volume.

22. A method as recited at claim 15 comprising, after the refrigerated storage period, removing the dough composition from the package, wherein the removed dough exhibits a released raw specific volume in a range from 1.3 to 1.4 cubic centimeters per gram.

23-25. (canceled)

26. A packaged dough product comprising a chemically leavened dough composition inside a pressurized package, the packaged dough product comprising:
a dimensionally stable outer package comprising two ends and an outer package volume between the ends, and
a flexible inner package at least partially contained by the outer package volume, the flexible package defining an interior volume,
wherein the packaged dough product can be stored for a refrigerated storage period of at least 4 weeks, and from the time the dough composition is placed in the flexible package and through the refrigerated storage period, the contained raw specific volume does not increase by more than 10 percent.

27. (canceled)

28. A packaged dough product as recited at claim 26 wherein
the dough composition is in the inner package, having a dough composition volume,
the dough composition has a contained raw specific volume of from about 0.9 to 1.1 cubic centimeters per gram as measured within the package,
the inner package contains less than 2 percent headspace and has an internal pressure of from about 7 to about 20 pounds per square inch (gauge); and
the dough composition volume is constrained in two dimensions by the outer package.

29-31. (canceled)

32. A packaged dough product as recited at claim 26 wherein the dough composition has a contained raw specific volume of from 0.95 to 1.1 cubic centimeters per gram as measured within the package.

33-38. (canceled)
